(19) United States
(12) Patent Application Publication
(10) Pub. No.: US 2003/0037866 A1
(43) Pub. Date: Feb. 27, 2003

(54) Method of bonding a heat radiating sheet

(75) Inventors: Yoshitaka Aoki, Takasaki-shi (JP); Tsutomu Yoneyama, Annaka-shi (JP); Kenichi Isobe, Annaka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Shin-Etsu Chemical Co., Ltd., Tokyo (JP)

(21) Appl. No.: 10/223,369

(22) Filed: Aug. 20, 2002

(30) Foreign Application Priority Data
Aug. 22, 2001 (JP) 2001-251937

(51) Int. Cl. B32B 35/00

(52) U.S. Cl. 156/230

(57) ABSTRACT

A method of bonding a heat radiating sheet to the surface of a substrate such as a heat generating electronic component is provided. According to this method, a release sheet, which is coated on one surface with a transferable heat radiating material, is positioned on top of the substrate so that the surface coated with the heat radiating material contacts the substrate, and subsequently, a molding device with a contact surface of a required shape and surface area is positioned so that the contact surface contacts the rear surface of the release sheet positioned on the substrate, and pressure and/or heat is then applied and a heat radiating material layer of the required surface area and shape is transferred from the release sheet to the substrate surface. The heat radiating sheet can be bonded easily to the required section of the substrate surface, without requiring the use of an adhesive, and without requiring any prior processing of the heat radiating sheet.

### BACKGROUND OF THE INVENTION

1. Field of the Invention

The present invention relates to a bonding method for a heat radiating sheet which can be provided between the thermal interface of a heat generating electronic component such as an IC or LSI, and a heat radiating component or member such as a heat sink or a circuit board, for the purpose of cooling the electronic component through thermal conduction.

2. Description of Prior Art

Typical methods of bonding a heat radiating sheet to a heat radiating component or member on a circuit board or the like (hereafter described as a substrate) include methods such as that disclosed in U.S. Pat. No. 5,904,796, which require an adhesive to be provided on the surface of the heat radiating material, and methods such as that disclosed in Published Japanese Translation No. 2000-509209 of PCT International Publication, which in those cases in which a heat radiating sheet is bonded to a specific section of a substrate surface, require the heat radiating sheet to be processed and molded in advance to match the surface area and shape of that specified region.

### SUMMARY OF THE INVENTION

An object of the present invention is to provide a bonding method for a heat radiating sheet which enables the heat radiating sheet to be bonded easily to a specified section of a substrate surface, without requiring the use of an adhesive, and without requiring any prior processing of the heat radiating sheet.

The inventors of the present invention discovered that they were able to achieve the above object using the method outlined below.

Namely, a first aspect of the present invention provides a method of bonding a heat radiating sheet to a substrate surface, comprising the steps of:

positioning a release sheet, which is coated on one surface with a heat radiating material which is transferable at ambient temperature, on top of the substrate so that the surface coated with the heat radiating material contacts the substrate, and

positioning a molding device with a contact surface of a required surface area and shape so that the contact surface contacts the other surface of the release sheet positioned on the substrate, and then applying pressure and transferring a heat radiating material layer of the required surface area and shape from the release sheet to the substrate surface.

Furthermore, a second aspect of the present invention for achieving the aforementioned object provides a method of bonding a heat radiating sheet to a substrate surface, comprising the steps of:

positioning a release sheet, which is coated on one surface with a heat radiating material which is transferable when heated, on top of the substrate so that the surface coated with the heat radiating material contacts the substrate, and

positioning a molding device with a contact surface of a required shape and surface area so that the contact surface contacts the other surface of the release sheet positioned on the substrate, and then heating the release sheet and transferring a heat radiating material layer of the required surface area and shape from the release sheet to the substrate surface.

### BRIEF DESCRIPTION OF THE DRAWINGS

FIG. 1 is an explanatory diagram describing a method of bonding a heat radiating sheet according to the present invention.

FIG. 2 is a perspective diagram showing examples of a molding device provided with a heating device used in a method of the present invention.

FIG. 3 is a diagram showing six heat sinks, each with a heat radiating sheet bonded to a specific section thereof, and a release sheet following processing, as obtained in the examples 1 and 2.

### DETAILED DESCRIPTION OF THE PREFERRED EMBODIMENTS

As follows is a more detailed description of the present invention, based on a series of embodiments.

(1) Positioning the Release Sheet on the Substrate:

According to the present invention, first, a release sheet which is coated on one surface with a heat radiating material which is transferable at ambient temperature, is positioned on top of a substrate so that the surface coated with the heat radiating material contacts the substrate. In the first aspect of the invention, the transferable heat radiating material uses a heat radiating material which can be transferred without heating, at an ambient temperature, typically from 10 to 30° C., and preferably from 15 to 25° C., whereas the second aspect of the invention uses a heat radiating material which can be transferred when heated, typically at a temperature of 60 to 80° C.

The release sheet performs the functions of supporting the heat radiating material, and promoting the transfer of the heat radiating material layer, and should consequently display a certain degree of mechanical strength and good releasability. Furthermore, in those cases in which the transfer of the heat radiating material layer is effected through heating (hereafter, also described as heat transfer), a certain degree of heat resistance is also required. Examples of preferred materials include organic resins such as polyester, polyethylene and polypropylene. In order to improve the releasability of the surface of the release sheet, the sheet should preferably be precoated with a releasing agent such as a silicone resin or a fluororesin. There are no particular restrictions on the thickness of the release sheet, although typical values are from 50 to 100 μm.

The heat radiating material must be able to be transferred from the aforementioned release sheet. This transferable heat radiating material includes materials which are transferable at ambient temperature, without heating, in the case of the first aspect of the present invention, and heat radiating materials which are transferable when heated in the case of the second aspect. What are described here as “heat radiating materials which are transferable when heated” include all heat radiating materials which are able to be transferred upon heating, including not only those materials which need to be softened by heating before becoming transferable, but also those materials which are actually transferable without heating, but are also transferable under heated conditions. Consequently, depending on the specific heat radiating material used, the material may be able to be used in both the aforementioned first aspect and the second aspect of the present invention.

The transferable heat radiating material typically incorporates a heat conducting filler and an organic polymer as essential constituents, and an example of the organic polymer is silicone resin. Examples of suitable heat conducting fillers include metals such as copper and aluminum, metal oxides such as zinc oxide, alumina and silica, metal nitrides such as aluminum nitride, silicon nitride and boron nitride, as well as other common heat conducting fillers such as graphite and artificial diamond, and these fillers may be used singularly, or in combinations of two or more materials.

Many heat transferable heat radiating materials are known, including those disclosed in Published Japanese Translation No. 2000-509209 of PCT International Publication, and those disclosed in a large number of other prior patent publications. Furthermore in recent years, heat transferable heat radiating materials containing silicone resins have been developed with the aim of improving fire resistance and softness, and these materials are ideal as the heat radiating material used in the present invention.

The thickness of the heat radiating material layer coated onto the release sheet is typically from 50 μm to 500 μm, and preferably from 100 μm to 250 μm.

Examples of the substrate onto which the aforementioned release sheet is positioned include heat generating electronic components such as an LSI or the like used in a CPU, driver IC, or memory component of an electronic device such as a personal computer, a digital video disc player or a mobile telephone.

(2) Transfer of the Heat Radiating Material:

In the first aspect of the present invention, in a second step, a molding device with a contact surface of a required shape and surface area is positioned so that this contact surface contacts the release sheet positioned on the substrate, on the opposite surface to the surface on which the coating of the heat radiating material is provided, and pressure is then applied and a heat radiating material layer of the required surface area and shape is transferred from the release sheet to the substrate surface. In the second aspect of the present invention, a molding device is brought into contact with a release sheet, in the same manner as the first aspect, and the release sheet is then heated, and a heat radiating material layer of the required surface area and shape is transferred from the release sheet to the substrate surface.

The molding device which is used in the present invention has a contact surface of a required surface area and shape, which contacts the release sheet. As a result, the entire heat radiating material layer provided on one surface of the release sheet is not simply transferred to the substrate surface, but can be transferred as a layer of a required shape and surface area.

There are no particular restrictions on the material of the molding device provided the functions and effects described above can be achieved, although from the viewpoint of manufacture, in those cases in which the device is manufactured by molding, suitable materials include a moldable metal such as aluminum or SUS, or a moldable synthetic resin with a certain degree of mechanical strength, which also displays a certain degree of heat resistance in those cases in which heat transfer is used. A specific example is a polycarbonate or the like with an adequate degree of hardness.

In the second aspect of the invention, a heat transferable material is used as the heat radiating material, and although pressure is not necessarily required, pressure may also be applied if necessary. Depending on the nature of the heat radiating material, simply bringing the heated contact surface of the molding device into contact with the heat radiating material coated release sheet may not generate a good contact between the heat radiating material layer and the substrate, and may result in an unsatisfactory bond. In such a case, it is preferable that the release sheet is pressed against the substrate using the pressure of the molding device. The pressure used should be within a range from 3.4×10 kPa (5 psi) to 6.9×10² kPa (100 psi), and preferably within a range from 1.4×10² kPa (20 psi) to 3.4×10² kPa (50 psi). The device used should preferably be a device equipped with this type of pressure function. The heating temperature used during a heat transfer will vary depending on the type of heat radiating material used, and although there are no particular restrictions, typically a heating temperature of approximately 50 to 80° C. is preferred.

The molding device comprises, for example, a contact section with a contact surface which contacts the release sheet, and a support section which supports the contact section, and the contact section should preferably be detachable from the support section. If the contact section is detachable, then a contact section can be selected which has a contact surface which corresponds with the shape and surface area of the heat radiating material layer to be transferred to the substrate, and this selected contact section then attached to the support section.

In order to achieve heating via the molding device, the molding device must either comprise a heat generating device, or be connected to a separately provided heat generating device in a manner which enables thermal conduction, and the aforementioned release sheet can then be heated at the contact surface. For example, a molding device could be used which comprises a heat generating section, and a heat conducting section for transmitting the heat generated by the heat generating section through to the contact surface. In the case of the example described above, the heat generating device (heat source) could be provided within the support section, or alternatively, a heat generating section with a heat generating device could be provided separately from the support section, and the contact section could be formed from a material with good thermal conduction, thereby performing the function of a heat conducting section. In either case, it is important that the heat generated by the heat generating device is effectively transmitted through to the contact surface. Nichrome wiring or the like can be used for the heat generating element of the heat generating device. The heat conducting section and the contact surface should preferably be formed from a metal with a comparatively high thermal conductivity, such as copper.

As follows is a more detailed description of the method of the present invention, based on the drawings.

Transfer Without Heating

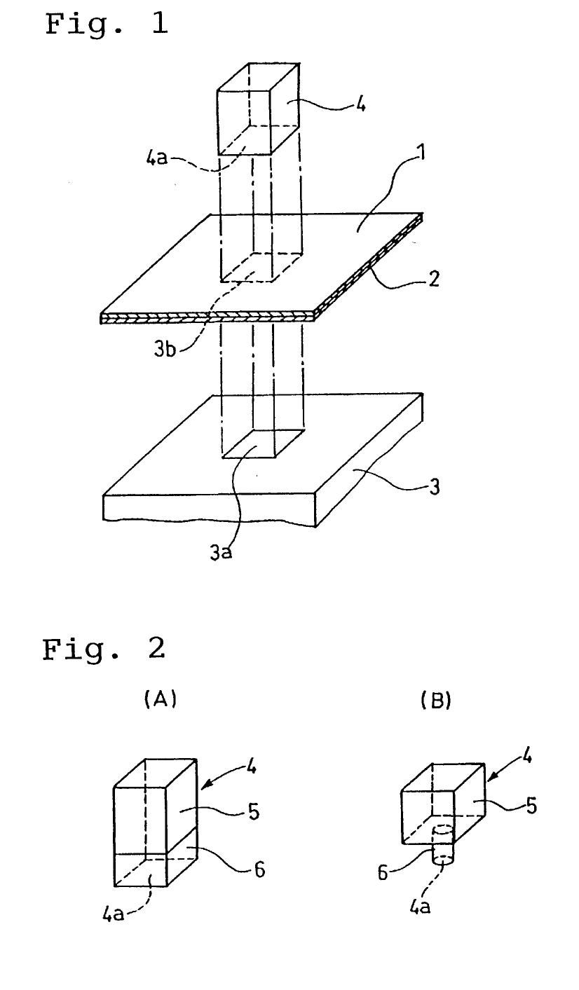

In FIG. 1, a release sheet 1 coated with a transferable heat radiating material is positioned above a substrate 3 so that the coating of the heat radiating material (the heat radiating material layer) 2 covers a section of the substrate surface 3a which is to be covered with a heat radiating sheet. In FIG. 1, for purposes of clarity, the thickness of both the release sheet and the heat radiating material layer have been exaggerated. Subsequently, a molding device 4 is positioned directly above the aforementioned section to be covered 3a (a square shape in the example shown in FIG. 1) above the corresponding location 3b on the release sheet 1 (in the example in FIG. 1, a contact surface 4a of the molding device 4 which contacts the release sheet 1 is a square shape which corresponds with the aforementioned section 3a). Next, the release sheet 1 is pressed onto the substrate 3 with a suitable pressure using the molding device 4. The molding device is then withdrawn, and the release sheet 1 is peeled away from the substrate 3. As the release sheet 1 is peeled away, within the section 3b of the release sheet subjected to pressure by the molding device, the heat radiating material layer is transferred and bonded to the required section 3a on the substrate surface, whereas in the other sections, the heat radiating material layer does not bond to the substrate, and is removed with the release sheet. In this manner, a heat radiating sheet can be bonded to only the required location 3a on the substrate surface.

Transfer with Heating

In this case, a molding device 4 incorporating a heating device is used, and with the exceptions that the heat radiating material coated onto one surface of the release sheet utilizes a material that becomes transferable when heated, and the fact that pressure is not necessarily required when the molding device 4 is brought in contact with the release sheet and heated, the process is basically the same as the above case in which heating was not required. A heat generating device (heat source), either provided within the molding device 4 or provided as a separate device, is supplied with power in order to heat a heat conducting section. Because the contact surface 4a between the heat conducting section and the release sheet is formed using a metal with a high thermal conductivity, the contact surface heats up rapidly. The contact is maintained for a period from several seconds to a dozen or more seconds, until the heat radiating material coating on the release sheet being contacted by the contact surface 4a melts. The heat supply to the contact surface 4a is then halted. Typically, the supply of heat can be halted by simply raising the molding device 4 up and away from the release sheet 1. Subsequently, the release sheet is left to stand for a period from several seconds to several minutes, allowing the release sheet 1, including the heat radiating material layer 2, and the substrate 3 to cool. By the time this cooling period has finished, the solidification of the heat radiating material layer 2 has caused the required section 3a contacted by the molding device 4 to be transferred and bonded to the substrate 3, whereas the other sections have not bonded. Following completion of the cooling period, the release sheet 1 is peeled away from the substrate 3, leaving a substrate in which only the required section 3a is covered with a heat radiating sheet.

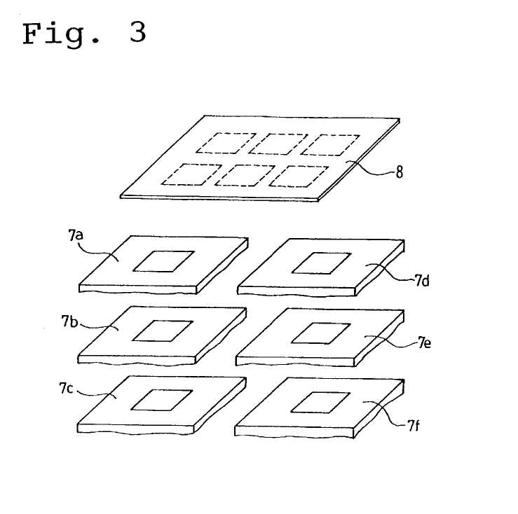

FIG. 2 is a structural diagram showing an example of a molding device used in a method of the present invention. In FIG. 2, the molding device 4 is constructed from a support section 5 and a contact section 6 so that a heat radiating material can be used to cover a predetermined location on a substrate surface with a sheet of a predetermined surface area and shape, and the heat radiating material can then be bonded to the substrate surface. The contact section is formed so that a contact surface 4a which contacts the release sheet is of a shape and surface area which corresponds with the aforementioned predetermined surface area and shape. The contact surface 4a is a square shape in the embodiment shown in FIG. 2(A) and a circular shape in the embodiment shown in FIG. 2(B), and consequently the corresponding contact sections 6 are a square shaped prism and a circular cylinder respectively. The contact section 6 should preferably be designed so as to be detachable from the support section 5.

In the second aspect of the present invention, a heat generating device (provided with a heat generating element such as nichrome wiring) can be provided on the support section, and the contact section should preferably be formed from a metallic material with good thermal conductivity, such as copper.

### EXAMPLES

### Example 1

A release sheet of polyethylene terephthalate coated with a 130 μm layer of a heat radiating material comprising mainly a heat conducting filler and silicone resin (brand name: PCS-TC-11 manufactured by Shin-Etsu Chemical Co. Ltd.) was positioned on a heat sink so that the heat radiating material layer contacted the heat sink surface. Next, a molding device was positioned in a location directly above a bonding location on the surface of the heat sink which required covering with a heat radiating sheet, and the release sheet was then pressed into contact with the heat sink surface with a pressure of 1.4×10² kPa (20 psi) for a period of 30 seconds. The molding device was then lifted off the release sheet, and when the release sheet was peeled away from the heat sink, a heat radiating material layer was transferred from the release sheet, only within the section where the molding device had been positioned, and this section of the heat radiating material layer was bonded to the heat sink surface to form a sheet like covering. Using the same release sheet, and repeating the operation for the heat sinks 7a, 7b, 7c, 7d, 7e and 7f enabled a heat radiating sheet of the required surface area and shape to be transferred and bonded to a specified location on the surface of each heat sink, and the remaining release sheet 8 displayed six regions where the heat radiating material had been removed by transfer to the six corresponding locations on the heat sinks, as shown in FIG. 3.

### Example 2

A release sheet of polyethylene terephthalate coated with a 130 μm layer of a heat radiating material comprising mainly a heat conducting filler and a polyolefin (brand name: X-65-705G6 manufactured by Shin-Etsu Chemical Co. Ltd.) was positioned on a heat sink so that the heat radiating material layer contacted the heat sink surface. Next, a molding device with a contact surface heated to 70° C. was positioned on the release sheet in a location directly above a bonding location on the surface of the heat sink which required covering with a heat radiating sheet, and the heated contact surface was held in contact for a period of 30 seconds until the heat radiating material layer melted. The molding device was then lifted off the release sheet, and the sheet was left to stand for 3 minutes to allow the heat radiating material layer, the release sheet and the heat sink to cool. When the release sheet was subsequently peeled away from the heat sink, a heat radiating material layer was transferred from the release sheet, only within the section where the molding device had been positioned, and this section of the heat radiating material layer was bonded to the heat sink surface to form a sheet like covering. By repeating the operation for the six heat sinks in the same manner as the example 1, the same effect as that shown in FIG. 3 was achieved.

### Example 3

A release sheet of polyethylene terephthalate coated with a 130 μm layer of a heat radiating material comprising mainly a heat conducting filler and a polyolefin (brand name: X-65-705G6 manufactured by Shin-Etsu Chemical Co. Ltd.) was positioned on a heat sink so that the heat radiating material layer contacted the heat sink surface. Next, a molding device with a contact surface heated to 70° C. was positioned on the release sheet in a location directly above a bonding location on the surface of the heat sink which required covering with a heat radiating sheet, and the heated contact surface was then pressed into contact with the heat sink surface with a pressure of 0.7×10² kPa (10 psi) for a period of 10 seconds until the heat radiating material layer melted. The molding device was then lifted off the release sheet, the sheet was left to stand for 3 minutes, to allow the heat radiating material layer, the release sheet and the heat sink to cool. When the release sheet was subsequently peeled away from the heat sink, a heat radiating material layer was transferred from the release sheet, only within the section where the molding device had been positioned, and this section of the heat radiating material layer was bonded to the heat sink surface to form a sheet like covering. By repeating the operation for the six heat sinks in the same manner as the example 1, the same effect as that shown in FIG. 3 was achieved, and a good bonding of the heat radiating sheet to the six heat sinks was achieved.

For the purposes of comparison, the transfer and bonding of a heat radiating. material layer was conducted under exactly the same conditions as the example 3, with the exception that no pressure was applied during the contact between the molding device and the release sheet, and a heat radiating material layer was transferred from the release sheet, only within the section where the molding device had been positioned, and bonded to the heat sink surface to form a sheet like covering. When the operation was repeated for six heat sinks in the same manner as the example 3, essentially the same effect as that shown in FIG. 3 was achieved. However, the bonding strength at one of the heat sinks was somewhat unsatisfactory, although not sufficiently so to cause any practical problems.

According to a method of the present invention, a heat radiating sheet can be bonded easily to a specified section of a substrate surface, without requiring the use of an adhesive, and without requiring any prior processing of the heat radiating sheet. By using the technology provided by the present invention, the automatic installation of a heat radiating sheet can be performed with ease.

What is claimed is:

1. A method of bonding a heat radiating sheet to a substrate surface, comprising the steps of:
positioning a release sheet, which is coated on one surface with a heat radiating material which is transferable at ambient temperature, on top of said substrate so that said surface coated with said heat radiating material contacts said substrate, and
positioning a molding device with a contact surface of a required shape and surface area so that said contact surface contacts an opposite surface of said release sheet positioned on said substrate, and then applying pressure and transferring a heat radiating material layer of a required surface area and shape from said release sheet to said substrate surface.

2. A method according to claim 1, wherein said release sheet is formed from an organic resin.

3. A method according to claim 2, wherein said release sheet formed from an organic resin is coated with a releasing agent.

4. A method according to claim 1, wherein said molding device comprises a contact section with a contact surface which contacts said release sheet, and a support section which supports said contact section, and said contact section is detachable from said support section.

5. A method according to claim 1, wherein said heat radiating material which is transferable at ambient temperature is a mixture of an organic polymer with a melting point which is not lower than room temperature, and a heat conducting filler.

6. A method according to claim 5, wherein said organic polymer with a melting point which is not lower than room temperature is a silicone resin.

7. A method according to claim 5, wherein said heat conducting filler is any one of a metal, a metal oxide, a metal nitride, graphite, artificial diamond, and a mixture of two or more thereof.

8. A method according to claim 1, wherein a thickness of said heat radiating material coating on one surface of said release sheet is within a range from 50 μm to 500 μm.

9. A method according to claim 1, wherein said substrate is a heat generating component.

10. A method of bonding a heat radiating sheet to a substrate surface, comprising the steps of:
positioning a release sheet, which is coated on one surface with a heat radiating material which is transferable when heated, on top of said substrate so that said surface coated with said heat radiating material contacts said substrate, and
positioning a molding device with a contact surface of a required shape and surface area so that said contact surface contacts an opposite surface of said release sheet positioned on said substrate, and then heating said release sheet and transferring a heat radiating material layer of a required surface area and shape from said release sheet to said substrate surface.

11. A method according to claim 10, wherein said release sheet is formed from an organic resin.

12. A method according to claim 11, wherein said release sheet formed from an organic resin is coated with a releasing agent.

13. A method according to claim 10, wherein when said molding device contacts said release sheet positioned on said substrate, said release sheet is subjected to pressure by said molding device.

14. A method according to claim 10, wherein said molding device either incorporates a heat generating device or is connected to a separately provided heat generating device in a manner which enables thermal conduction, and said release sheet can be heated by said contact surface.

15. A method according to claim 10, wherein said molding device comprises a contact section with a contact surface which contacts said release sheet, and a support section which supports said contact section, and said contact section is detachable from said support section.

16. A method according to claim 10, wherein said heat radiating material which is transferable when heated is a mixture of an organic polymer with a melting point which is not lower than room temperature, and a heat conducting filler.

17. A method according to claim 16, wherein said organic polymer with a melting point which is not lower than room temperature is a silicone resin.

18. A method according to claim 16, wherein said heat conducting filler is any one of a metal, a metal oxide, a metal nitride, graphite, artificial diamond, and a mixture of two or more thereof.

19. A method according to claim 10, wherein a thickness of said heat radiating material coating on one surface of said release sheet is within a range from 50 μm to 500 μm.

20. A method according to claim 10, wherein said substrate is a heat generating component.
